(19) United States
(12) Patent Application Publication
(10) Pub. No.: US 2009/0100699 A1
(43) Pub. Date: Apr. 23, 2009

(54) GOLF GLOVE DRYING DEVICE

(76) Inventor: William E. Hasler, Branson West, MO (US)

Correspondence Address: HUSCH BLACKWELL SANDERS LLP, 4801 Main Street, Suite 1000, KANSAS CITY, MO, 64112, US

(21) Appl. No.: 12/253,694

(22) Filed: Oct. 17, 2008

Related U.S. Application Data
(60) Provisional application No. 60/981,281, filed on Oct. 19, 2007.

(51) Int. Cl. D06F 59/04; F26B 25/00

(52) U.S. Cl. 34/106; 34/104; 224/274

(57) ABSTRACT

A golf glove drying apparatus is provided. The apparatus includes a selectively expandable and contractible sleeve having an airflow path therethrough. A mounting device is provided for mounting the sleeve to a golf cart.

### CROSS-REFERENCE TO RELATED APPLICATIONS

This application is a nonprovisional of and claims priority to U.S. Provisional Application Ser. No. 60/981,281, filed Oct. 19, 2007, which document is hereby incorporated by reference to the extent permitted by law.

### BACKGROUND OF THE INVENTION

The playing of golf, particularly in the summer and in southern climates, will often result in wetting of the glove or gloves worn by the golfer from sweating. For many players, this means the glove is not useable. While a golfer may carry multiple gloves to play, there is a practical limit on how many gloves a golfer may wish to carry. It would therefore be desirable, to provide a glove drying apparatus for use on golf mobility devices such as powered golf carts.

### SUMMARY OF THE INVENTION

The present invention involves the provision of a glove drying device particularly suited for mounting on a golf cart particularly a powered golf cart. The glove drying device includes a sleeve that is self-adjustable for various sizes of gloves and adapted to grip the glove to retain the glove in place thereon for drying. A mounting device such as a clip bracket is secured to the sleeve for mounting the sleeve to a golf cart. The sleeve has an air flow passage for allowing air to flow into the interior of the glove particularly during movement of the golf cart.

Other and further objects of the invention, together with the features of novelty appurtenant thereto, will appear in the course of the following description.

### BRIEF DESCRIPTION OF THE SEVERAL VIEWS OF THE DRAWING

In the accompanying drawings, which form a part of the specification and are to be read in conjunction therewith in which like reference numerals are used to indicate like or similar parts in the various views:

FIG. 1 is an isometric view of a glove drying device.

FIG. 2 is a top plan view of an alternate embodiment of the glove drying apparatus.

FIG. 3 is a side view of the glove drying apparatus of FIG. 2.

### DETAILED DESCRIPTION OF THE INVENTION

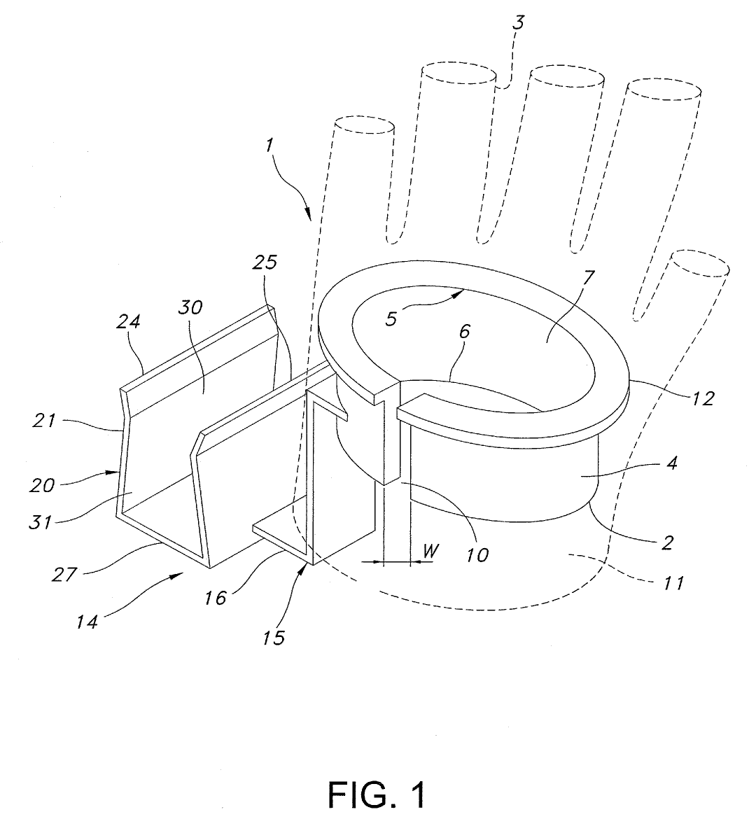

The reference numeral 1 designates generally a golf glove drying apparatus. The apparatus 1 includes a sleeve 2 adapted to receive a glove thereover and be in contact with an inside surface of a cuff of the glove 3. The glove 3 is shown in broken lines in FIG. 1. The glove 3 may be of an open finger design or a closed finger design. Typically, such gloves are made of leather and are usually made of a thin leather that when exposed to appropriate conditions, will dry relatively quickly. The sleeve 2 has an outer peripheral surface 4 that is sized and shaped for engagement with an interior surface of the glove 3 to grip and retain the glove 3 at a predetermined position thereon while permitting its easy removal. In a preferred embodiment, the sleeve 2 is a tubular member having opposite open ends 5, 6. The surface 4 is shown as smooth but could have grooves (not shown) to provide areas not in contact with the glove 3 thereby exposing more of the interior of the glove 3 to air. The sleeve 2 defines an axial flow passage 7 that extends between the open ends 5, 6.

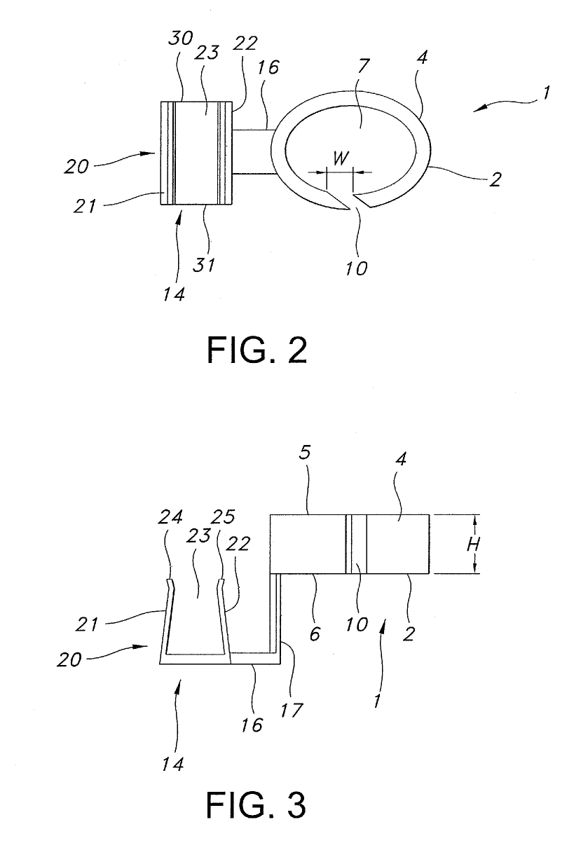

The passage 7 permits flow of air into the glove 3 and through the glove 3 in the event the glove 3 is of an open finger design or has material components that permit the flow of air therethrough. To accommodate different sizes of gloves, and to help retain a glove in position on the sleeve 2, the sleeve 2 is provided with an expansion means such as expansion slot 10. The slot 10 extends between opposite ends 5, 6 and allows selective peripheral expansion and contraction of the sleeve 2. The sleeve 2 may be formed of any suitable material, for example, molded polymeric material such as polyethylene, polypropylene, nylon and other suitable resiliently deformable plastic materials. In a preferred embodiment, the height H of the sleeve 2 is on the order of ½ inch to 2 inches. As shown, the sleeve 2 may be of any suitable cross sectional shape, for example, generally round, oval or the like. As shown, the sleeve 2 is particularly adapted for receiving the glove cuff area 11 i.e., that portion of the glove that fits over the hand between the base of the thumb and the wrist area. For men's glove, a peripheral dimension around the exterior of the sleeve 2 is on the order of about 6 to 8 inches. The slot 10 has a width W so as to permit the retention of various sizes of gloves. An outwardly projecting and circumferentially extending rib 12 (FIG. 1) may be provided on the sleeve 2 to assist in retaining glove 3 and provide an air gap between portions of sleeve 2 and glove 3. The rib 12 may be adjacent either of the ends 5, 6 or intermediate the ends. FIGS. 2, 3 show an alternate embodiment of the apparatus 1 which does not have the rib 12.

Means is provided for mounting the sleeve to the golf cart. As herein used, the term golf cart is used generally and includes such things as powered golf carts. Such golf carts, (not shown) are well known and need not be described. Such golf carts are available from a variety of companies, for example, EZ Go, Club Cart and Yamaha. Many will have supports for holding a roof, rails for retaining golf club bags, bumpers and fenders all having exposed edge portions.

The apparatus 1 includes means 14 for mounting the sleeve 2 to the golf cart. One embodiment is shown in the Figures. The retainer means 14 includes an L bracket 15 secured to the sleeve 2 in a generally longitudinal axis direction of the sleeve. The L bracket has legs 16, 17 with the leg 17 being secured to and extending from the sleeve 2. The L bracket may be an integral part of the sleeve 2. The bracket 15, in the illustrated embodiment, spaces the sleeve 2 from its attachment point on the golf cart. The leg 17 provides for a longer length of the glove cuff 11 to be received over the sleeve 2.

The retainer means 14 further includes a securement device designated generally 20 adapted for releaseably securing or otherwise securing the sleeve 2 to a golf cart. Preferably, the securement device 20 is configured and oriented to permit the end 6 which receives the wrist portion of the glove 3 to face into the direction of movement of the golf cart during its normal forward operation. The device 20 may be adjustably mounted on the bracket 15 to permit changing the position of the sleeve 2 relative to the bracket 20 if desired. In the illustrated structure, the device 20 is in the form of a channel clip having a pair of spaced apart resiliently deformable arms 21, 22 having an opening 23 therebetween. The legs 21, 22 may be tapered toward the free edges 24, 25 of the legs to assist in mounting the device 1 to a golf cart. The legs 21, 22 are connected by a bight portion 27. The angle between the bight 27 and a leg 21, 22 can be on the order of about 60° to 90°. The legs 21, 22 and bight 27 form a channel with the open side 23 and opposite open ends 30, 31. Other forms of devices may be used to attach the apparatus 1 to a golf cart. For example, hook and loop fastener devices may be used to removably mount the apparatus 1. Mechanical fasteners may be used to permanently or semi-permanently mount the apparatus 1 to a golf cart. If permanently attached, the mounting means 14 could be of a breakaway type to reduce the risk of damage. The apparatus 1 may additionally be adhesively secured to a golf cart. For removable mounting, the securement device 20 may be removably mounted to a fender well, a roof support, a rail or the like of the golf cart.

The apparatus 1 may be made by molding using a thermoplastic polymer. In another alternate embodiment, a peripherally outwardly extending rib (not shown) may be positioned on the outer periphery of the sleeve 2 adjacent one of the ends 5 or 6 or at a position intermediate thereto to help retain a glove thereon during use of the apparatus 1.

From the foregoing it will be seen that this invention is one well adapted to attain all ends and objects hereinabove set forth together with the other advantages which are obvious and which are inherent to the structure.

It will be understood that certain features and subcombinations are of utility and may be employed without reference to other features and subcombinations. This is contemplated by and is within the scope of the claims.

Since many possible embodiments may be made of the invention without departing from the scope thereof, it is to be understood that all matter herein set forth or shown in the accompanying drawings is to be interpreted as illustrative, and not in a limiting sense.

What is claimed is:

1. A golf glove drying apparatus adapted for mounting on a golf cart, the apparatus comprising:
a sleeve having opposite open ends defining an airflow path therethrough, said sleeve having an expansion joint to permit selective expansion and contraction of the outer perimeter size of the sleeve; and
a mounting device secured to the sleeve adapted for mounting the sleeve to a golf cart.

2. The apparatus of claim 1 wherein the mounting device being configured for a removable mounting of the sleeve to the golf cart.

3. The apparatus of claim 1 wherein the mounting device includes a bracket secured to the sleeve extending therefrom at least partially in a longitudinal direction, and the bracket secured to a clip having opposite legs defining a channel therebetween, said legs having opposite free ends being selectively movable toward and away from one another for frictionally retaining the apparatus on a golf cart.

4. The apparatus of claim 3 wherein the clip is affixed to the golf cart.

5. The apparatus of claim 1 wherein a golf glove is mounted on one of the open ends of the sleeve.

6. The apparatus of claim 1 wherein the mounting device is affixed to the golf cart using a fastener.

7. The apparatus of claim 6 wherein the fastener is a hook and loop fastener, a mechanical fastener, a breakaway fastening device, or an adhesive fastener.
